(19) United States
(12) Patent Application Publication
(10) Pub. No.: US 2002/0068624 A1
(43) Pub. Date: Jun. 6, 2002

(54) Gambling credit card and method therefor

(76) Inventor: Gary E. Ellis, Henderson, NV (US)

Correspondence Address: WEISS & MOY PC, 4204 NORTH BROWN AVENUE, SCOTTSDALE, AZ, 85251, US

(21) Appl. No.: 09/730,664

(22) Filed: Dec. 6, 2000

(51) Int. Cl. G06F 17/00

(52) U.S. Cl. 463/25

(57) ABSTRACT

A system and method for a casino to grant a line of credit to a person gambling without the casino risking losing any out of pocket cash prior to the gambler paying off the line of credit. The system and has the person apply for a line of credit from a casino. The casino then reviews the credit history of the person gambling. A casino smart card is then programmed with a predetermined cash value based on the person's credit history. The casino smart card is then credited or debited based on the person's wins and loses at the casino.

### BACKGROUND OF THE INVENTION

1. Field of the Invention

This invention relates to casino gaming and, more specifically, to a system and method for a casino to grant a line of credit to a person gambling (the “customer”) without the casino having to risk the customer leaving the casino with cash winnings prior to paying off the line of credit that has been granted.

2. Description of the Prior Art

Over the years, casino gambling has gained in popularity. Today, more people are participating in casino gambling than ever before. As the number of people who gamble increases, the greater the need for casinos to issue credit to consumers. This includes those individuals who traditionally have not been able to secure such credit for a variety of different reasons. Many casinos and clubs do not have a sophisticated credit issuing and tracking system. Furthermore, many of these casinos and clubs do not have the ability to properly track customers' debt when a customer cashes out or leaves the casino.

Casinos like to make it convenient for their customers to gamble. Many customers do not like to carry large sums of cash. When the casino grants the customer a line of credit, the casino is basically allowing the customer to gamble with the casino's money. However, since many casinos do not have the proper mechanisms in place to properly monitor lines of credit, some customers are able to take advantage of the casino.

For example, a customer may frequent a casino for a period of time. The owner, seeing that the person is a frequent customer, may grant the person a line of credit/marker. The casino may give the customer $100.00 in cash, tokens, or chips with which to go gamble. The person may gamble for a short time (using very little of the cash, tokens, or chips) and then cash out and leave the casino. Before the casino realizes it, the person is gone with the casino's money.

Similarly, an individual may frequent a casino for a period of time. The person may cash checks in order to receive cash, tokens, or chips in which to gamble. Once a relationship is established, the person may one day cash a bogus check. Again, the person may gamble for a short period of time (using very little of the cash, tokens, or chips) and then cash out and leave the casino. Before the owner realizes it, the person is gone with the casino's money.

Additionally, an individual may utilize one or both of these methods in multiple casinos. Presently, there is not a centralized system or method of tracking gamblers losses and or credit/markers that have been extended. An improved tracking system would reduce the risk of customers leaving the casino with the casino's money before the debt has been repaid.

Therefore, a need existed to provide an improved system and method that would allow casinos and clubs to establish lines of credits with customers. The improved system and method would allow casinos and clubs, or a designated third party, to establish lines of credits with customers and reduce the risk of the customer leaving the casino with cash winnings prior to paying off the line of credit. The improved system and method would further reduce the risk of casinos and clubs of losing house cash by fraudulent transactions.

### SUMMARY OF THE INVENTION

In accordance with one embodiment of the present invention, it is an object of the present invention to provide an improved system and method that would allow casinos and clubs, either internally or through a third party, to establish lines of credits with customers.

It is another object of the present invention to provide an improved system and method that would allow casinos and clubs, either internally or through a third party, to establish lines of credits with customers and reduce the risk of the customer leaving the casino with cash winnings prior to paying off the line of credit.

It is another object of the present invention to provide an improved system and method that would allow casinos and clubs, either internally or through a third party, to establish lines of credits with customers and reduce the risk of the customer leaving the casino with cash winnings prior to paying off the line of credit and reduce the risk to the casinos and clubs of losing house cash by fraudulent transactions.

### BRIEF DESCRIPTION OF THE PREFERRED EMBODIMENTS

In accordance with one embodiment of the present invention a method for a casino to grant a line of credit to a customer while minimizing a risk of losing any out of pocket cash prior to the customer paying off the line of credit is disclosed. The method comprising the steps of: applying for a line of credit from a casino by the person gambling; review of credit history by the casino of the person gambling; programming a centralized computer monitoring system with a predetermined casino credit based on the person gambling's credit history; and crediting and debiting the casino credit based on the person gambling wins and loses.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

FIG. 1 is a front view of a video gambling machine display which uses the gambling credit line card and method of the present invention.

FIG. 2 is a front view of a casino marker smart card which is used in the present invention.

FIG. 3 is a flowchart which depicts the method of the present invention.

### DETAILED DESCRIPTION OF THE PREFERRED EMBODIMENT

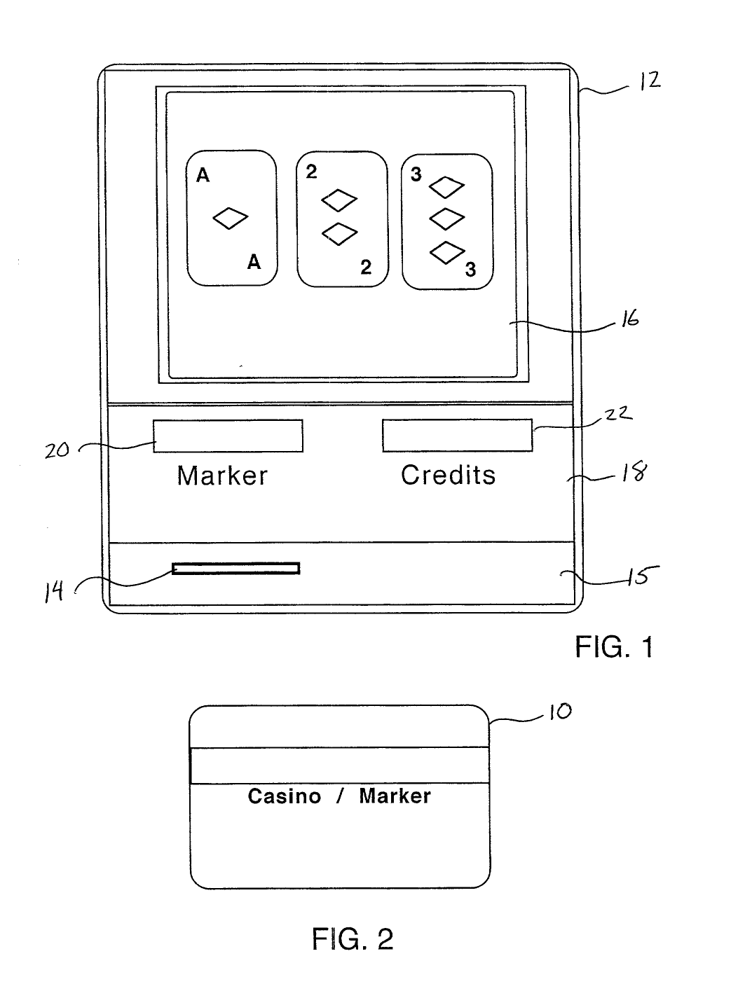

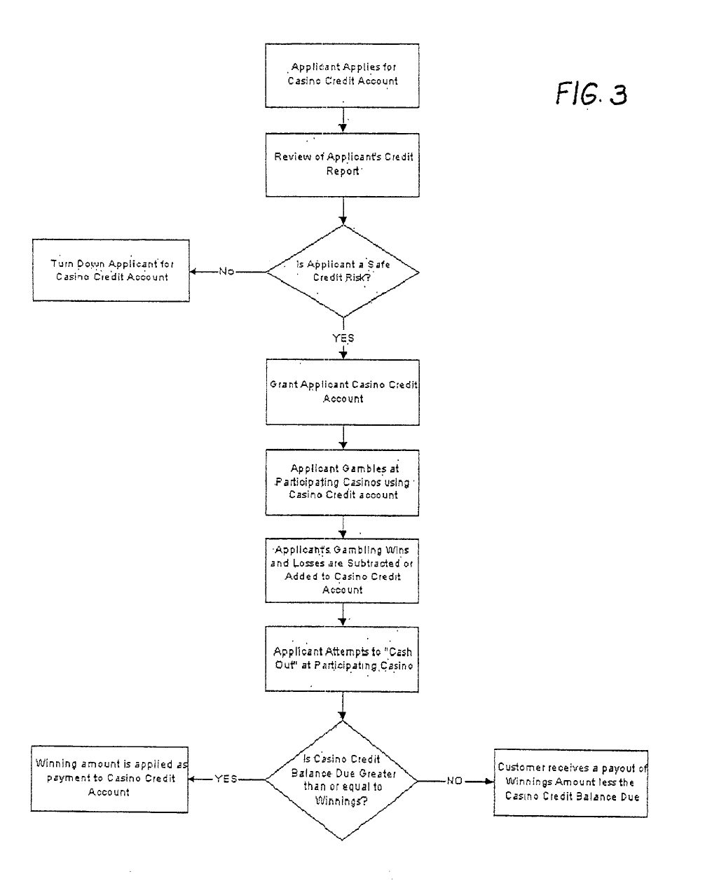

Referring to FIGS. 1-3 the gambling credit card and method of the present invention will be disclosed. As stated above, many casinos like to make it convenient for customers to gamble by giving their guests lines of credits and/or markers. A customer may apply to a casino, or a third party, to receive casino credit. Alternatively, the customer may receive casino credit as part of a marketing campaign, an example of which would be utilizing direct mail to target individuals that meet specific demographic characteristics related to income, spending habits, employment status, results of a player tracking system, or other criteria. The application process should be as convinient as possible for the customer. The customer may even apply for credit via an internet web page. Once the customer fills in the application and submits the form, the customer may receive a package of information when the customer arrives at the casino.

The casino, or the third party, may then elect to grant the applicant a casino credit/casino credit card 10. Generally speaking, the casino, or third party, would use similar criteria in establishing the limits of the casino credit account as a bank or credit card company would use to determine if a person should be granted a line of credit or credit card. However, since the casino credit account is used only for gambling within the participating casinos and since this invention, as will be detailed further, will prevent the customer from leaving the casino with the casino's money, the criteria and standards for issuing casino credit may be less restrictive than for issuing a line of credit or credit card that may be used to purchase products of services.

When the applicant (hereinafter “consumer”) is approved, he/she will receive a casino credit account identified by the credit card 10 or other means of secure and unique identification (hereinafter “casino credit”). The casino, or third party, will then program the approved credit limit into a centralized computer system. The customer may then begin to use the casino credit to gamble but only in the casino, or group of casinos, that have agreed to participate in the casino credit system.

The casino credit may be used on gaming machines 12 or gaming tables. The casino credit would operate in the following manner. For a casino gaming machine 12 such as slot machines, video poker, video blackjack, video keno, and the like, the customer would be identified by either inserting the casino credit card 10 in a card reader 14 or otherwise providing secure and unique identification by using the input section 15. The input section 15 would allow an account number and personal identification number (PIN) to be entered into thee gaming machine 12. The customer may also be able to provide secure and unique information by a biometric security system which may be part of the input system 15. Such biometric security systems may include fingerprint scanning, retina scanning, or other biometric measuring systems. The same identification methods could also be applicable at a gaming table which would use the present system and method.

The casino gaming machines 12 will have a gaming display area 16 where the gambling activity is shown (i.e., where the cards or numbers are shown or where the tumblers are located on a slot machine). Below the gaming display area 16, is a monetary display area 18. The monetary display area 26 will have a marker display 20 and a credit display 22. The marker display 20 will show the active amount on the casino credit account. The credit display 22 shows how many credits the customer has on the gaming machine 12. For example, if the casino, or third party, programs the central system with a $300.00 credit limit, when the customer provides the appropriate identification, the marker display 20 will show an available gambling limit of $300.00, outstanding account balance of $0.00, and an amount available to gamble of $300.00.

The customer may then begin to gamble on the gaming machine 12 betting as many credits per turn as the gaming machine 12 allows. After each turn, the marker display 20 and the credit display 22 will be updated. For example, the customer decides to bet $5.00 of the $300.00 available and loses. The marker display 20 will now indicate a $300.00 gambling limit, an outstanding account balance of $5.00, an amount available to gamble of $295.00 and an amount available to cash out of $0.00.

If the customer had gambled $5.00 and won a total of $10.00, the marker display 20 would show a $300.00 gambling limit, an outstanding account balance of $0.00, an amount available to gamble of $295.00, and an amount available to cash out of $5.00. Thus, the customer may only receive cash for the amount in excess of that required to repay the outstanding balance of the casino credit account.

The customer may continue to gamble and go to different gaming machines 12 or gaming tables at any participating casino or group of casinos for as long as he/she desires. During the time the customer is gambling, the credit line/marker must first be paid off before the marker will read a positive value. The central system will prevent the customer from utilizing casino credit when the losses reach the predetermined credit limit. Further, the central system prevents the customer from obtaining cash or cashing out until the total balance due on the casino credit account is paid in full, irrespective of where the debt was incurred. only the winnings that are in excess of the credit account balance due may be cashed out by the customer.

A periodic reconciliation will be performed among participating casinos and/or the third party issuing the casino credit accounts to resolve any outstanding debts owed to or from each participant as a result of the customer's activity.

Even if the customer was able to obtain casino credit by providing false information, the casino is not out any actual money, since the customer is not able to cash out before first paying off the casino credit account.

If the customer leaves the casino with an outstanding balance on the casino credit account, the central system will maintain that balance and will produce periodic statements for presentation to the customer. The statements will indicate the status of the casino credit account and payment terms thereof. The central system will calculate and charge interest on outstanding amounts due and late fees on payments not made in accordance with the casino credit account agreement.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method for a casino to grant a line of credit to a customer while minimizing a risk of losing any out of pocket cash prior to the customer paying off the line of credit comprising the steps of:
applying for a line of credit from a casino by the person gambling;
review of credit history by the casino of the person gambling;
programming a centralized computer monitoring system with a predetermined casino credit based on the person gambling's credit history; and
crediting and debiting the casino credit based on the person gambling wins and loses.

2. The method of claim 1 further comprising the step of producing and delivering to the customer a periodic statement detailing gambling activity.

3. The method of claim 2 wherein the step of producing and delivering to the customer a periodic statement detailing gambling activity further comprises the step of detailing winnings and losses at each visit, total balance due, any finance charges and late fees, and payment terms.

4. The method of claim 1 wherein the casino is part of a group of casinos wherein the line of credit may be used in any of the group of casinos.

5. The method of claim 1 wherein the step of programming a centralized computer system further comprises the step of issuing a casino credit card for tracking the customer's gambling activity.

6. The method of claim 1 further comprising the step of settling by the customer with the casino when the customer is finished gambling.

7. The method of claim 6 wherein the step of settling further comprises the step of paying off the line of credit by the person gambling before the person gambling may receive any money won during gambling.

8. The method of claim 7 wherein the step of paying off the line of credit by the person gambling before the person gambling may receive any money won during gambling further comprises the step of offsetting any money won against the casino credit to reduce an outstanding balance.

9. The method of claim 1 wherein the step of applying for a line of credit further comprises the step of filing out a credit application by the customer.

10. The method of claim 1 wherein the steps of programming the centralized computer monitoring system further comprises the step of programming the centralized computer monitoring system with a maximum lose value which will stop the customer from continuing to gamble when the maximum lose value is reached.

11. The method of claim 1 further comprising the step of using the centralized computer monitoring system with an integrated player tracking system.

12. A method for a casino to grant a line of credit to a customer while minimizing a risk of losing any out of pocket cash prior to the customer paying off the line of credit comprising the steps of:
applying for a line of credit from a casino by the person gambling;
review of credit history by the casino of the person gambling;
programming a centralized computer monitoring system with a predetermined casino credit based on the person gambling's credit history;
crediting and debiting the casino credit based on the person gambling wins and loses;
producing and delivering to the customer a periodic statement detailing gambling activity.

13. The method of claim 12 wherein the step of producing and delivering to the customer a periodic statement detailing gambling activity further comprises the step of detailing winnings and losses at each visit, total balance due, any finance charges and late fees, and payment terms.

14. The method of claim 12 wherein the casino is part of a group of casinos wherein the line of credit may be used in any of the group of casinos.

15. The method of claim 12 wherein the step of programming a centralized computer system further comprises the step of issuing a casino credit card for tracking the customer's gambling activity.

16. The method of claim 12 further comprising the step of settling by the customer with the casino when the customer is finished gambling.

17. The method of claim 16 wherein the step of settling further comprises the step of paying off the line of credit by the person gambling before the person gambling may receive any money won during gambling.

18. The method of claim 17 wherein the step of paying off the line of credit by the person gambling before the person gambling may receive any money won during gambling further comprises the step of offsetting any money won against the casino credit to reduce an outstanding balance.

19. The method of claim 12 wherein the step of applying for a line of credit further comprises the step of filing out a credit application by the customer.

20. The method of claim 12 wherein the steps of programming the centralized computer monitoring system further comprises the step of programming the centralized computer monitoring system with a maximum lose value which will stop the customer from continuing to gamble when the maximum lose value is reached.
